(19) United States
(12) Patent Application Publication
(10) Pub. No.: US 2003/0084115 A1
(43) Pub. Date: May 1, 2003

(54) Facilitating contextual help in a browser environment

(76) Inventors: Timothy E. Wood, Seattle, WA (US); Christopher J. Beiter, Seattle, WA (US)

Correspondence Address: RICK D. NYDEGGER, WORKMAN, NYDEGGER & SEELEY, 100 Eagle Gate Tower, 60 East South Temple, Salt Lake City, UT, 84111, US

(21) Appl. No.: 09/963,914

(22) Filed: Sep. 26, 2001

(51) Int. Cl. G06F 15/16

(52) U.S. Cl. 709/217; 709/203

(57) ABSTRACT

Improving event-based windowing in a network environment. After a client retrieves an electronic document, the client detects a reference in the document to computer-executable instructions not included in the document. The client then retrieves the computer-executable instructions as well as relevant predefined event-based content that is to be displayed in response to a predetermined event. If a predetermined event occurs, the processing of the computer-executable instructions results in a window having the predefined content to be displayed over the document. The window is not easily preempted by other processes. Also, the computer-executable instructions permit a wide variety of formatting of the text within the window, and is not limited to images.

### BACKGROUND OF THE INVENTION

1. The Field of the Invention

The present invention relates to the field of browser technology. Specifically, the present invention relates to facilitating event-driven floating windows, such as contextual help windows, appearing over documents in a browser environment.

2. Background and Related Art

Documents have been used to communicate ideas for many millennia. Typically, documents have been drafted by applying physical pressure via a writing implement, such as a pen or pencil, to an impressionable medium, such as paper.

More recently, computers have been used to draft documents that may then be stored in accordance with a recognized data format on an electronic medium. Such documents will be called herein “electronic” documents. Currently, electronic documents may be drafted in a variety of different formats using various software applications that recognize the corresponding data format. For example, Microsoft® Word may be used to draft electronic documents in a variety of electronic formats such as, for example, the Microsoft® Word format (with the “.doc” extension), as well as formats such as HTML that are interpretable by a Web browser.

One advantage of electronic documents, as compared to physical documents, is that software applications may implement added features, such as contextual help, on electronic documents. In contextual help, for example, when the mouse cursor is moved to a certain area of the document, a floating window appears superimposed on the document at about the position of the mouse cursor. The floating window may display instructive information regarding the use of icons or other tools in that area of the document. Thus, the user may be guided on the overall use of the electronic document by appropriate movement of the mouse cursor. This type of contextual help is widespread in conventional non-browser applications.

One conventional method for extending such event-driven windowing into a browser environment involves the use of an “alt” attribute in HTML. The “alt” attribute allows document authors to specify alternative text to display in the place of an image should an image not be displayed. However, even if the image is displayed, some browsers display the alternative text (at least for a brief period) near the image when the user moves the mouse cursor over the corresponding image.

Another conventional method is to use HTML “title” attributes. Some browsers implement “title” attributes in a similar manner as described above for “alt” attributes. Specifically, some text associated with a title attribute will appear if a mouse cursor is moved to a certain area of the screen.

Although useful, the “alt” and “title” attributes of HTML have limitations that may be considered significant in the context of contextual help. In particular, there is little flexibility on how the associated text is formatted when displayed. For example, the text may not be bolded, listed using bulleted or numbered items, or the like. In a contextual help environment, the primary aim is to convey information to the user in an understandable manner. Sometimes, a user may best understand the contextual help if the associated text is formatted in a certain way. Therefore, conventional “alt” and “title” attributes have definite limitations when implementing contextual help in a browser environment.

Conventionally, “div” tags in Dynamic HTML (or DHTML) have been used to implement contextual help in a browser environment. Such “div” tags may be used to implement contextual help such that there is much greater flexibility in how the pop-up text is formatted. However, “div” tags suffer in that the associated pop-up text is often preempted by other processes such as frames, drop-down list boxes, ActiveX (E controls, custom controls, and other commonly occurring processes. Accordingly, the associated text may often never be displayed in response to a designated mouse event.

An additional disadvantage of all of these conventional methods as currently implemented is that if there is a need for the associated text to change for a number of electronic documents, each of those documents would need to be edited thus involving cost associated with revising electronic documents and comparing the documents to ensure consistency.

Accordingly, what is desired are methods, systems, and computer program products for facilitating event-driven floating windows in a browser environment while reducing the chance that the display of the floating window will be preempted by another display process. It would represent a further advancement if this advantage were obtained while allowing more flexibility in the formatting of the floating window content, and while allowing for more efficient editing of the floating window content.

### SUMMARY OF THE INVENTION

Methods, systems and computer program products are described for improving event-based windowing in a network environment. More specifically, a document is first retrieved from a server. For example, when a user selects a hyperlink that corresponds to the address of the document, the browser application may, with the aid of the operating system, generate and dispatch a request for the document over the network. The server then responds to the request by downloading the document to the client.

As the browser application of the client interprets the document, the browser application detects a reference in the document to computer-executable instructions not included in the document. For example, the HyperText Markup Language (HTML) standard allows for the inclusion of a “script tag” in the document. Next, the client retrieves the computer-executable instructions.

While retrieving the computer-executable instructions, the client may also retrieve event-based content from a database. This event-based data includes information that might potentially be displayed in a window that is to overly the document in response to events. For example, if the content is contextual help for different regions of the document, then the relevant event-based data may be, for example, the contextual help text and layout information that would be displayed in response to a cursor movement over any of the areas of the displayable form of the document.

If a predetermined event occurs, a window having predefined content is displayed over the displayable form of the document. For example, in the case of contextual help, the event may be the movement of a pointing device to a certain region of the document. The predefined content displayed in the window may be information helpful in ascertaining how to use controls within that certain region of the document.

The downloaded computer-executable instructions are then executed so as to overlay the content over the displayable form of the document in response to the event. The execution may generate, for example, a scriptlet ActiveX® window in accordance with the scriptlet technology of Microsoft® Internet Explorer version 4.0. Specifically, the scriptlet retrieves content in response to the event and displays the content in a window over the document.

There are numerous advantages to using the principles of the present invention over conventional techniques. As a first advantage as compared to the use of “div” tags in DHTML, the floating window is not easily preempted by other processes and thus appears above the document even if the document uses frames, drop-down list boxes, ActiveX® controls, custom controls, and other commonly occurring processes. This is because the scriptlet control is not easily preempted by these processes.

Second, the temporary display of text using conventional “alt” and “title” attributes of HTML is limited in the layout and formatting of the associated text. In contrast, the scriptlet control in accordance with the present invention allows a wide variety of formatting of the text within the window.

Third, in order to change the associated text in the context of conventional methods, there needs to be a change to the document itself. For example, the “alt” or “title” attribute or the “div” tag would need to be changed to refer to the different text. In contrast, the principles of the present invention do not require any change to the document. All that would be changed is the computer-executable instructions that are downloaded. Accordingly, changes may be propagated through multiple documents in an efficient manner, without having to check every document that uses the scriptlet.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 illustrates a browser user interface in accordance with the present invention in which the cursor of a pointing device is not placed within a region that results in a pop-up window appearing over the document;

FIG. 3 illustrates the browser user interface of FIG. 2 in which the cursor is moved to within a region that results in a pop-up window appearing over the document;

FIG. 4 schematically illustrates components of a network system in which the present invention may operate;

FIG. 5 illustrates a flowchart of a method of the client of FIG. 4 overlaying content over the displayable form of the document in response to an event in accordance with the present invention; and

FIG. 6 illustrates the salient components of the document structure of FIG. 4.

### DETAILED DESCRIPTION OF THE INVENTION

The present invention extends to methods, systems and computer program products for overlaying content, such as contextual help, over the displayable form of a document (such as a Web page) in response to an event. For example, when a user points a mouse cursor over a certain region of a Web page, a contextual help window is displayed over the Web page. The contextual help window may then describe useful information regarding any icons or tools associated with that region of the Web page. The principles of the present invention allow the content to be displayed over the document in a manner that other processes do not easily preempt the display of this content. In addition, the formatting of the content is flexible, allowing elements such as bulleted list items and other formatting elements. Also, the content may be changed without having to redesign the Web page itself.

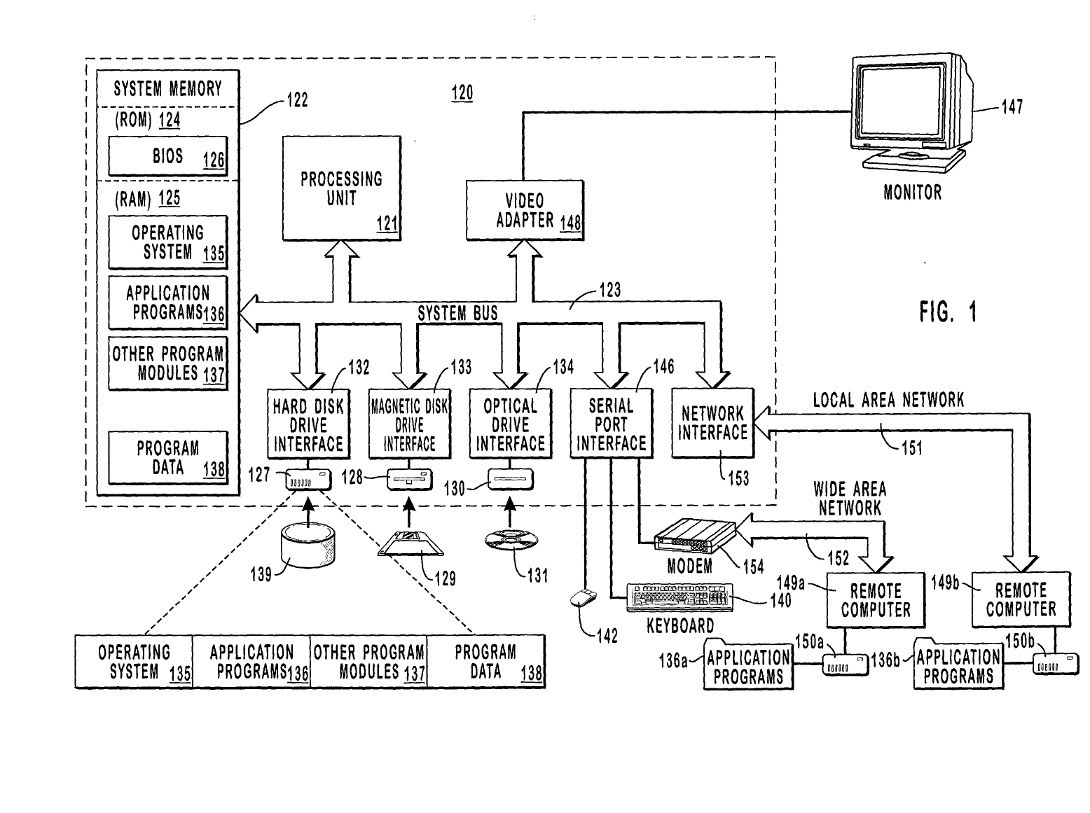

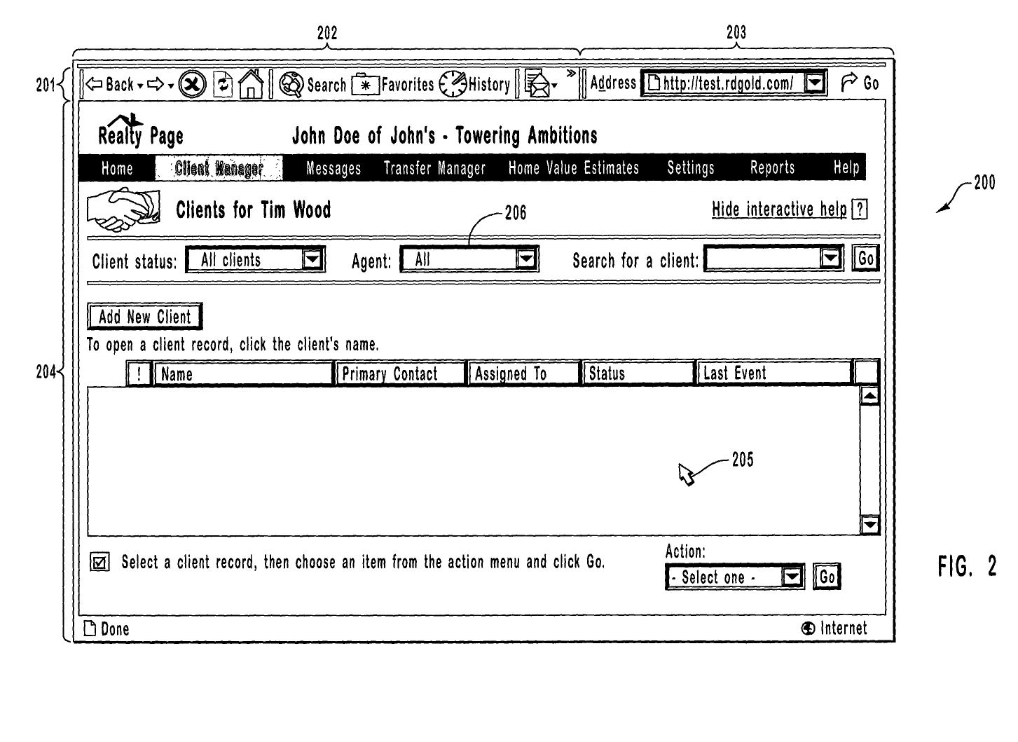

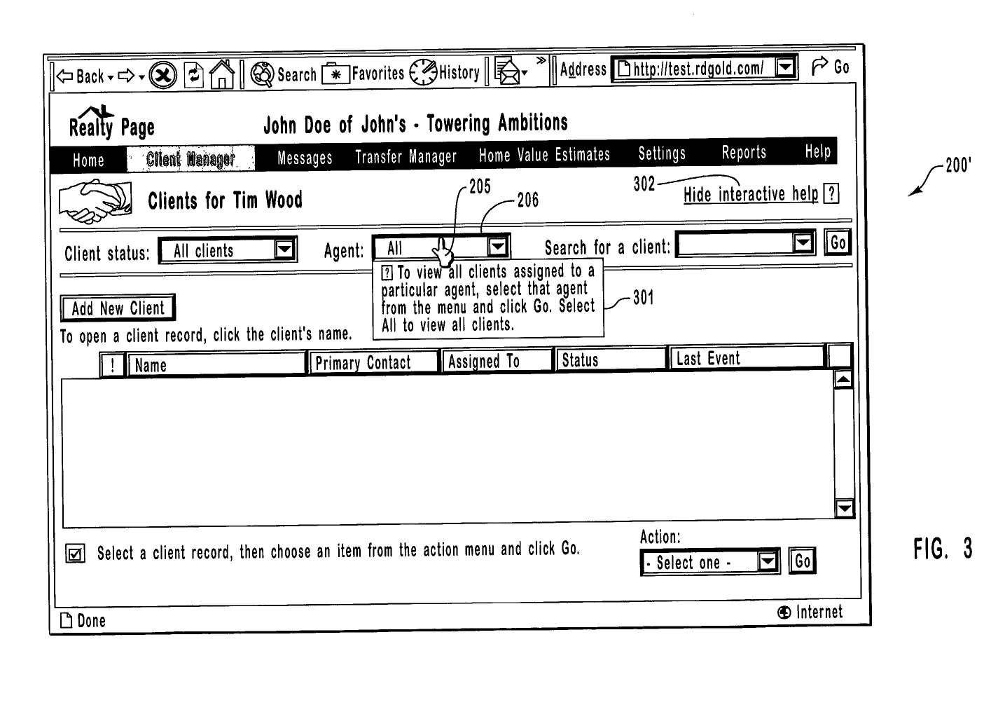

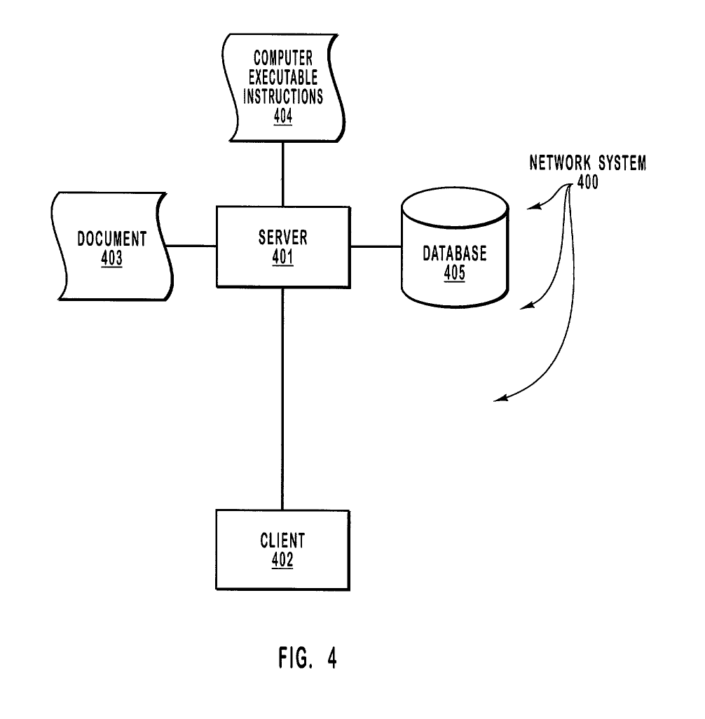

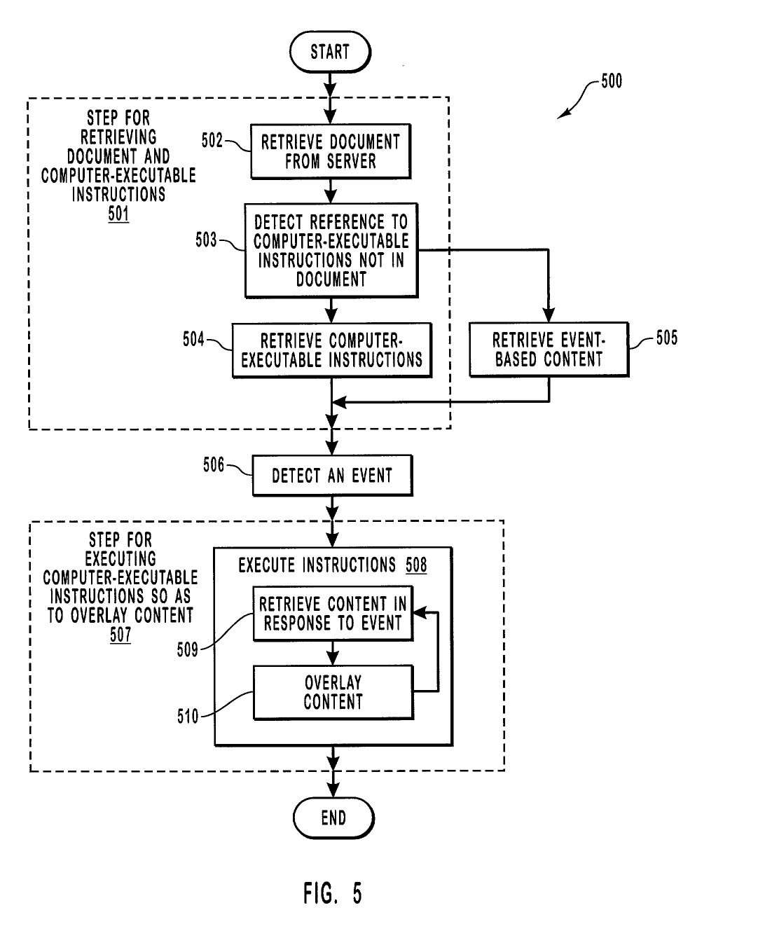

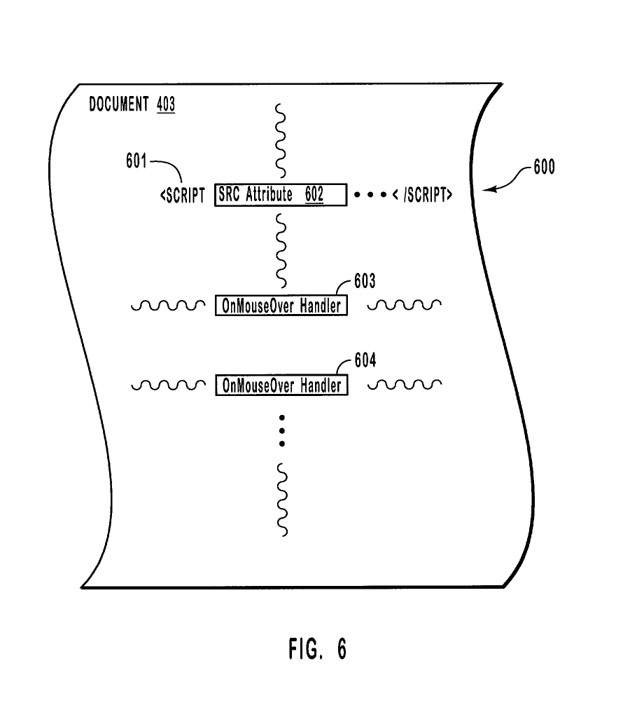

First, a suitable operating environment for the principles of the present invention will be described with reference to FIG. 1. Then, a user experience enabled by the principles of the present invention will be described with reference to FIGS. 2 and 3. Next, various operations performed in accordance with the present invention will be described with reference to FIG. 4, FIG. 5 and FIG. 6.

The embodiments of the present invention may comprise a special purpose or general purpose computer including various computer hardware, as discussed in greater detail below. Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise physical storage media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 120, including a processing unit 121, a system memory 122, and a system bus 123 that couples various system components including the system memory 122 to the processing unit 121. The system bus 123 may be any of several types of bus structures including a memory bus or memory controller, a peripheral bus, and a local bus using any of a variety of bus architectures. The system memory includes read. only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive-interface 133, and an optical drive interface 134, respectively. The drives and their associated computer-readable media provide nonvolatile storage of computer-executable instructions, data structures, program modules and other data for the computer 120. Although the exemplary environment described herein employs a magnetic hard disk 139, a removable magnetic disk 129 and a removable optical disk 131, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 146 coupled to system bus 123. Alternatively, the input devices may be connected by other interfaces, such as a parallel port, a game port or a universal serial bus (USB). A monitor 147 or another display device is also connected to system bus 123 via an interface, such as video adapter 148. In addition to the monitor, personal computers typically include other peripheral output devices (not shown), such as speakers and printers.

The computer 120 may operate in a networked environment using logical connections to one or more remote computers, such as remote computers 149a and 149b. Remote computers 149a and 149b may each be another personal computer, a server, a router, a network PC, a peer device or other common network node, and typically include many or all of the elements described above relative to the computer 120, although only memory storage devices 150a and 150b and their associated application programs 136a and 136b have been illustrated in FIG. 1. The logical connections depicted in FIG. 1 include a local area network (LAN) 151 and a wide area network (WAN) 152 that are presented here by way of example and not limitation. Such networking environments are commonplace in office-wide or enterprise-wide computer networks, intranets and the Internet.

When used in a LAN networking environment, the computer 120 is connected to the local network 151 through a network interface or adapter 153. When used in a WAN networking environment, the computer 120 may include a modem 154, a wireless link, or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing communications over wide area network 152 may be used.

FIG. 2 illustrates a browser user interface 200 that may be displayed on, for example, the monitor 147 of the computer 120. The browser user interface is generated by a browser application such as one of application programs 136 in collaboration with an operating system such as operating system 135.

As illustrated, the browser user interface 200 has an upper region 201 that includes a navigational toolbar 202 that includes icons to assist the user in navigating and searching for network resources such as Web pages. In addition, the upper region 201 includes an address toolbar 203 where a Uniform Resource Locator (URL) may be entered. The browser user interface 200 also includes a display region 204 in which the displayable form of an electronic document may be displayed to the user.

The electronic document may be, for example, a HyperText Markup Language (HTML) document that is interpreted by the browser application. The display region 204 displays a page having the content and layout described by the electronic document. For example, in the display region 204 of FIG. 2, the browser user interface 200 is displaying a Realty Page for John Doe of John's Towering Ambitions. However, as one skilled in the art will easily recognize, the browser user interface may be used to display the displayable form of a practically limitless diversity of content.

A typical user interface will include a pointing device cursor such as cursor 205 which is movable by a user via pointing device 142. For example, a user may move the cursor 205 from the position illustrated in FIG. 2 to a new position such as, for example, over an “agent” field 206 that allows the user to select a corresponding real estate agent.

FIG. 3 illustrates the browser user interface 200′ after the cursor 205 has moved to within a region defined by the agent field 206. When the cursor 205 moves to the agent field 206, a window 301 appears over the displayable form of the document. The window 301 includes content that, for example, provides contextual help related to the agent field 206. Thus, the user may learn how to use the agent field 206 through the contextual help message. Should a user desire to disable the contextual help, the user may select the text “Hide interactive help” 302.

Thus, from a user's perspective, the principles of the present invention allow a user to receive contextual help in reviewing and navigating the displayable form of electronic documents. While the principles of the present invention are useful in providing contextual help in a network environment, the present invention is not so limited. Also, as will be described hereinafter, the principles of the present invention may be applied to applications in which a window appears over the displayable form of a document regardless of whether the event is the movement of a cursor to within a certain region, and regardless of whether the context of the overlying window represents contextual help.

FIG. 4 schematically illustrates, in simplified form, a network system 400 in which the present invention may operation. The network system includes at least one server computer system 401 that is “network connectable” to at least one client computer system 402.

In this description and in the claims, “network connectable” means having the ability to be “network connected” at least on a temporary basis, and “network connected” means having the ability to communicate either directly or indirectly through one or more intervening networks.

In this description and in the claims, a “computer system” is defined as a group of one or more interconnected computing devices that cooperatively perform one or more functions. A “computing device” is defined as any device that is capable of processing information. For example, a computer system may be as large as being a large cluster of highly capability servers, or may be as small as a digital telephone, Personal Digital Assistant (PDA), or other like devices.

In addition, a “server” or “server computer system” is defined as any computer system that provides a service to another computer system. A “client” or “client computer system” is defined as any computer system that receives a service from another computer system. Naturally, a computer system may both provide services and receive services. Accordingly, a “server” in one context may be a “client” in another context. For example, client 402 may act as a server in some contexts.

The server computer system 401 hosts an electronic document 403 and computer-executable instructions 404 so as to be able to download the document 403 and instructions 404 as appropriate to the client 402. In addition, the server computer system 401 has access to a database 405.

FIG. 5 is a flowchart of a method 500 of the client 402 overlaying content over the displayable form of the document in response to an event in accordance with the present invention. FIG. 6 illustrates the relevant structure of the electronic document 403 of FIG. 4. The method of FIG. 5 will be described with frequent reference to the elements of FIG. 4 and FIG. 6.

Initially, the method includes a step 501 for retrieving the document 403 and the associated computer-executable instructions 404 from the server. This may be accomplished using, for example, the corresponding acts 502, 503, and 504.

Specifically, the document 403 is retrieved from the server (act 502). This may be accomplished, for example, by the client 402 generating a request for the document and transmitting the request to the server 401. For example, when a user selects a hyperlink that corresponds to the address of the document 403, or when a user enters an address of the document in the address toolbar 203, the browser application may, with the aid of the operating system, generate and dispatch a request for the document 403. The server 401 then responds to the request by downloading the document 403 to the client 402. Other techniques for retrieval may involve the server 401 automatically downloading the document without an express request from the client 402.

As the browser application of the client 402 parses and otherwise interprets the document 403, the browser application detects a reference in the document 403 to computer-executable instructions not included in the document (act 503). For example, the HyperText Markup Language (HTML) standard allows for the inclusion of a “script tag” in the document. The script tag may include a source identifier that indicates the address of the computer-executable instructions 404. For example, the script tag may take the following form:

<script src=“URL”> . . . </script>

<script . . . > represent the start of the script element and </script> represents the end of the script element. scr=“URL” identifies the source of the computer-executable instructions where “URL” is replaced by the Uniform Resource Locator (URL) of the computer-executable instructions 404. FIG. 6 illustrates relevant portions of document 403. The document 403 may include script tag 601 with the SRC attribute 602 embedded therein.

Next, the client 402 retrieves the computer-executable instructions (act 504). In response to detecting script references such as this, many browsers such as Microsoft® Internet Explorer version 4.0 and subsequent versions automatically generate and transmit a request for the script using the URL identified in the script tag. The server 401 then transmits the computer-executable instructions to the client 402. The computer-executable instructions may be, for example, a scriptlet that is consistent with the scriptlet technology inherent in Microsoft® Internet Explorer version 4.0 and subsequent versions.

The computer-executable instructions 404 may be specific to the document 403. This may be accomplished by designating a single querystring parameter in the script tag that identifies the document 403. Methods for designating querystring parameters in script tags are known to those of ordinary skill in the art. The server that hosts the computer-executable instructions 404 receives the querystring parameter and determines that the computer-executable instructions 404 are appropriate to download based on the URL provided in the request and based on the querystring parameter that identifies the document 403. This completes the step for retrieving the document 403 and the computer-executable instructions 404.

While retrieving the computer-executable instructions 404, the client 402 may also retrieve event-based content (act 505). This may be accomplished, for example, by the server 401 using the querystring parameter that identifies the document 403 in order to compile relevant event-based data from the database 405. This relevant event-based data includes information that might potentially be displayed in a window that is to overly the document in response to events. For example, if the content is contextual help for different regions of the document 403, then the relevant event-based data may be, for example, the contextual help text and layout information that would be displayed in response to a cursor movement over any of the areas of the displayable form of the document 403. The information is compiled into an eXtensible Markup Language (XML) document and delivered to the client 402.

In accordance with the present invention, a window is displayed over the displayable form of the document if an event occurs. Accordingly, the method includes an act of detecting an event (act 506). The only requirement of the event is that the event be detectable. For example, if the event were the movement of the cursor to a certain region of the screen, an “OnMouseOver” handler in accordance with the HTML standard may be used to detect that the mouse cursor has moved to within certain specified boundaries. In FIG. 6, the document 403 is illustrated as having several OnMouseOver handlers 603 and 604 although there is no limit to the number of such handlers in a specific document.

The method also includes a step for executing the computer-executable instructions so as to overlay the content over the displayable form of the document in response to the event (step 507). Specifically, the client 402 may execute the computer-executable instructions 404 (act 508). The execution of the computer-executable instructions may generate a scriptlet in accordance with the scriptlet technology of Microsoft® Internet Explorer version 4.0 and that implements acts 509 and 510.

Specifically, the scriptlet retrieves content in response to the event (act 509). For example, if the event is the movement of a cursor to a given region, the OnMouseOver handler may pass a parameter to the scriptlet informing of the occurrence of the event. In response, the scriptlet maps the specific event to the content that is to be retrieved. Accordingly, the scriptlet then retrieves the content that is to overly the displayable form of the document (act 510), and displays the content in a window over the document.

While the principles of the invention may be implemented by a wide variety of languages using a wide variety of routines, the following javascript source code listing represents an example of computer-executable instructions 404 that may be used to facilitate contextual help in response to mouse-over events. This example is provided by way of illustration only, and not by way of limitation.

<%@ Language=“javascript” %>
<%
//-------------------------------------------------------------------------------------=
// PURPOSE: contains script for contextual help mouseovers
//
// NOTES: this file should be included into the file at the location where you want
// the on/off link for the intereactive help to show up.
//-------------------------------------------------------------------------------------=
Response.ContentType = “application/x-javascript”;
var strTemp = Request.QueryString(“pageid”).Item;
//-------------------------------------------------------------------------------------=
%>
<!-- #INCLUDE VIRTUAL=“/ util/cookies.js” -->
// configuration constants

| | | |
|---|---|---|
| var myTimer | = 0; | // global |
| timer variable | | |

| | | |
|---|---|---|
| var g_iWidth | = 185; | // width of help |
| column | | |

| | | |
|---|---|---|
| var g_iDistanceFromSide | = g_iWidth + 15; | // second value controls |
| distance from right side of browser | | |

| | | |
|---|---|---|
| var g_iTimerDelay | = 100; | // hidemenu |
| mouseout delay | | |

| | | |
|---|---|---|
| var g_bStylesApplied | = false; | // controls associated with the |
| stylesheets | | |
| var g_bScriptletReady | = false; | // set to true when onload event |
| fires on the scriplet object | | |

| | | |
|---|---|---|
| var g_bHelpOn | = true; | // |
| controls showing and hiding | | |

| | |
|---|---|
| var g_strShowHelpTxt | = “Show interactive help” |
| var g_strHideHelpTxt | = “Hide interactive help” |
| // write out the on/off switch | |

document.write(“<TABLE ALIGN=‘right’ class=‘text_heading_medium’ clear=‘all’
border=‘0’ cellpadding=‘0’ cellspacing=‘0’><TR valign=‘bottom’><TD nowrap=‘1’>”);
document.write(“<A HREF=‘javascript:HelpOnOff( )’><SPAN ID=‘spanOnOff’>”);
document.write(getShowHidePreference( ))
document.write(“</SPAN></TD><TD><IMG SRC=‘/clearlead/images/faqicon.gif’
hspace=‘3’ vspace=‘0’ border=‘0’ align=‘middle’ clear=‘all’/></A>”);
document.write(“</TD></TR></TABLE>”);
// write scriptlet object
document.write (“<OBJECT name=‘srcMenu’ id=‘scrMenu’ align=‘right’ data=‘/
help/HelpContextScriptlet.htm’ style=‘Z-INDEX: 2; POSITION:
ABSOLUTE;DISPLAY:none;’ type=‘text/x-scriptlet’></OBJECT>”);
// write XML data island
document.write (“<XML ID=‘dsoCTXHelp’
SRC=‘/help/getctxhelp.asp?pageid=<%strTemp%>’></XML>”);
<%
//-------------------------------------------------------------------------------------=
// interactive help functions
//-------------------------------------------------------------------------------------=
%>
// diplays menu via scriptlet, called by onmouseover event on designated control
function showMenu(strCTXID)
{

if(g_bHelpOn && g_bScriptletReady && dataIslandReady( ))
{

var strTipText = getTipFromXML(strCTXID)
event.srcElement.attachEvent(“onmouseout”, hideMenuTimed);
// only show if there is data
if (strTipText != ″ && strTipText != null)
{

stopTimer( );
var objMenu = document.all.scrMenu;
objMenu.setupMenu(strTipText);
setObjXPosition( );
objMenu.style.display = ″;
if (!g_bStylesApplied)
{

hideMenuTimed( );
g_bStylesApplied = true;
showMenu(strCTXID);

}
window.event.cancelBubble = true;

}

}

}
// resizes the object height to compensate for dynamically modified content
function resizeObject(iHeight)
{

document.srcMenu.height = iHeight + 5;
document.srcMenu.width = g_iWidth;

}
// moves the object when the user resizes the browser window
// controls up/down and left/right position of tooltip
function setObjXPosition( )
{

var objMenu = document.all.scrMenu;
var objFind = event.srcElement;
var iX = 0;
var iY = 0;
// find element coordinates
do
{

iX += objFind.offsetLeft;
iY += objFind.offsetTop;
objFind = objFind.offsetParent;

}
while (objFind.tagName != ‘BODY’ && objFind.tagName != ”)
// then set the menu object's X property
if (document.body.clientWidth < (iX + g_iWidth))
{

iX = iX − ((iX + g_iWidth) − document.body.clientWidth);

| } | |
|---|---|
| objMenu.style.posLeft = iX; | |
| // then set the menu object's Y property | |
| var iObjHeight = objMenu.getHeight( ); | // height of the menu |
| var scrollY = document.body.scrollTop; | // length down the screen the user has |

scrolled

// menu height + element Y position + element height > document height + length

scrolled down the screen

if((iObjHeight + iY + event.srcElement.offsetHeight > scrollY +

document.body.clientHeight))

{

objMenu.style.posTop = iY − iObjHeight − 4;

}
else
{

objMenu.style.posTop = iY + event.srcElement.offsetHeight;

}
resizeObject(iObjHeight);

}
// get data from the XML data island and pass it to setupMenu
function getTipFromXML(strCTXID)
{

var i, CTXTipNode;
var strTempTip = “”;
var nodeXMLDoc = document.all(“dsoCTXHelp”).XMLDocument;
var CTXTipList = nodeXMLDoc.getElementsByTagName(“TIP”);
for (i = 0; i < CTXTipList.length; i++)
{

CTXTipNode = CTXTipList.item(i);
var strIDVal = CTXTipNode.getAttribute(“ID”);
if (strIDVal == strCTXID)
{

strTempTip = CTXTipNode.firstChild.nodeValue;
break;

}

}
return(strTempTip);

}
// duh
function closeMenu( )
{

document.all.srcMenu.clearMenu( );
document.all.scrMenu.style.display = ‘none’;

}
// delay hiding of timer to prevent flickers
function hideMenuTimed( )
{

if (g_bHelpOn && document.all.srcMenu.style.display != ‘none’ &&

g_bScriptletReady && dataIslandReady( ))

{

// mouseout event is only null when the scriptlet BODY fires this function
// so in this case, don't do SELECT tag validation because we know it's over

top of the scriptlet

// this prevents flickering of the help box when it is initialized by a

dropdown or other windowed control

if (event != null && event.fromElement != null)
{

// SELECT tag validation
var strTag = event.fromElement.tagName;
strTag = strTag.toUpperCase( );
// check if mouseout is being fired by funky SELECT tag behavior

(refires mouseover and mouseout repeatedly)

if(strTag == ‘SELECT’ && event.toElement == null)
{

window.event.cancelBubble = true;
return;

}

}
// first check to see if the timer is already running, if so stop it
if (myTimer != 0) { stopTimer( ); }
// set timer for X milliseconds before the menu will hide
myTimer = setTimeout(“closeMenu( )”,g_iTimerDelay);

}
return;

}
// helper function for menu
function stopTimer( )
{

// if the timer is running, stop it
if (myTimer != 0)
{
window.clearTimeout(myTimer);
myTimer = 0;
}

}
// user has asked to turn on or off the help
function HelpOnOff( )
{

// if on, then turn off
if (g_bHelpOn)
{

g_bHelpOn = false,
spanOnOff.innerText = g_strShowHelpTxt;
setCookie(‘showhelp’, ‘false’, 365, ‘/’);

}
// else, turn help back on
else
{

g_bHelpOn = true;
spanOnOff.innerText = g_strHideHelpTxt;
setCookie(‘showhelp’, ‘true’, 365, ‘/’);

}

}
// reads cookie, turns on or off the help, and shows the proper link text
function getShowHidePreference( )
{

// check the cookie
var strPref = getCookie(‘showhelp’);
// if true or null then set the g_bHelpOn to true and return the g_strHideHelpTxt

text

// reset cookie value to true
if (strPref == null ∥ strPref == true ∥ strPref == ‘true’)
{

setCookie(‘showhelp’, ‘true’, 365, ‘/’);
return(g_strHideHelpTxt);

}
// false, so set the g_bHelpOn to false and return the g_strShowHelpTxt text
else
{

g_bHelpOn = false; // hide help
return(g_strShowHelpTxt);

}

}
// callback from scriptlet body onload setting readystate
function scriptletReady( )
{

g_bScriptletReady = true;

}
// returns true or false depending on whether the data island ready state is complete
function dataIslandReady( )
{

var bRet = false;
var nodeXMLDoc = document.all(“dsoCTXHelp”).XMLDocument;
if (nodeXMLDoc.readyState == “complete” ∥ nodeXMLDoc.readyState == 4)
{

bRet = true;

}
return(bRet);

}

There are numerous advantages to using the principles of the present invention over conventional techniques. As a first advantage as compared to the use of “div” tags in DHTML, the floating window is not easily preempted by other processes and thus appears above the document even if the document uses frames, drop-down list boxes, ActiveX® controls, custom controls, and other commonly occurring processes. This is because the scriptlet control is not easily preempted by these processes.

Second, the temporary display of text using conventional “alt” and “title” attributes of HTML is limited in the layout and formatting of the associated text. In contrast, the scriptlet control in accordance with the principles of the present invention allows a wide variety of formatting of the text within the window. For example, the content of the window may be formatted with, for example, tables or bulleted lists, or the like.

Third, in order to change the associated text in the context of conventional methods, there needs to be a change to the document itself For example, the “alt”, “title” or “div” tag would need to be changed to refer to the different text. In contrast, the principles of the present invention do not require any change to the document. All that would be changed is the computer-executable instructions 404. The document 403 itself would remain the same. Accordingly, changes may be propagated through multiple document in an efficient manner, without having to check every document that uses the scriptlet.

Thus, the principles of the present invention enable improved methods, systems, and computer program products for event-based windowing in a network environment. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a network system that includes a server computer system network connectable to a client computer system, the server computer system hosting a document, the client computer system capable of interpreting the document for subsequent display of a displayable form of the document, a method of the client computer system overlaying content over the displayable form of the document in response to an event, the method comprising the following:
a specific act of retrieving the document from the server computer system;
a specific act of detecting a reference in the document to computer-executable instructions not included in the document;
a specific act of retrieving the computer-executable instructions;
a specific act of detecting an event; and
a specific act of executing the, computer-executable instructions to thereby implement the following:
a specific act of retrieving content in response to the event;
a specific act of overlaying the content over the displayable form of the document after retrieving the content.

2. A method in accordance with claim 1, wherein the specific act of retrieving the document from the server computer system comprises the following:
a specific act of retrieving a HyperText Markup Language (HTML) document from the server computer system.

3. A method in accordance with claim 2, wherein the specific act of detecting a reference in the document to computer-executable instructions not included in the document comprises the following:
a specific act of the detecting a SCRIPT tag in the HTML document.

4. A method in accordance with claim 1, wherein the specific act of retrieving the computer-executable instructions comprises the following:
a specific act of retrieving computer-executable instructions that operate to overly a window over the displayable form of the document even if other windows or frames already overly the displayable form of the document.

5. A method in accordance with claim 4, wherein the specific act of retrieving computer-executable instructions that operate to overly a window comprises the following:
a specific act of using the computer-executable instructions to generate a scriptlet.

6. A method in accordance with claim 1, wherein the specific act of detecting an event comprises the following:
a specific act of detecting that a pointer has moved to a certain region of the displayable form of the document.

7. A method in accordance with claim 6, wherein the specific act of retrieving content in response to the event comprises the following:
a specific act of retrieving help information related to the area of the displayable form of the document over which the pointer has moved.

8. A method in accordance with claim 1, wherein the specific act of retrieving the computer-executable instructions comprises the following:
a specific act of retrieving one or more data structures that represent at least some of the content that might be displayed in response to events that might occur while the displayable form of the document is being displayed.

9. A method in accordance with claim 1, wherein the specific act of retrieving one or more data structures comprises the following:
retrieving one or more data structures that are structured in accordance with the extensible Markup Language (XML) format.

10. In a network system that includes a server computer system network connectable to a client computer system, the server computer system hosting a document, the client computer system capable of interpreting the document for subsequent display of a displayable form of the document, a method of the client computer system overlaying content over the displayable form of the document in response to an event, the method comprising the following:
a step for retrieving the document and associated computer-executable instructions from the server computer system;
a specific act of detecting an event; and
a step for executing the computer-executable instructions so as to overlay the content over the displayable form of the document in response to the event.

11. In a network system that includes a server computer system network connectable to a client computer system, the server computer system hosting a document, the client computer system capable of interpreting the document for subsequent display of a displayable form of the document, a computer program product for implementing a method of overlaying content over the displayable form of the document in response to an event, the computer program product comprising a computer-readable medium having stored thereon the following:
computer-executable instructions for detecting a reference in the document to computer-executable instructions not included in the document;
computer-executable instructions for causing the computer-executable instructions not included in the document to be retrieved from the server computer system;
computer-executable instructions for retrieving content in response to a detected event; and
computer-executable instructions for overlaying the content over the displayable form of the document after retrieving the content.

12. A computer program product in accordance with claim 11, further comprising the following:
computer-executable instructions for causing one or more data structures to be retrieved, the one or more data structures representing at least some of the content that might be displayed in response to events that might occur while the displayable form of the document is being displayed.

13. A computer program product in accordance with claim 12, wherein the computer-executable instructions for retrieving content in response to a detected event comprise the following:
computer-executable instructions for retrieving the content from the one or more data structures.

14. A computer program product in accordance with claim 11, wherein the computer-readable medium is a physical storage media.

15. In a network system that includes a server computer system network connectable to a client computer system, the server computer system hosting a document, the client computer system capable of interpreting the document for subsequent display of a displayable form of the document, a method of the client computer system overlaying content over the displayable form of the document in response to an event, the method comprising the following:
a specific act of retrieving an HTML document from the server computer system;
a specific act of detecting a script tag in the HTML document;
a specific act of retrieving computer-executable instructions identified by the script tag, the computer-executable instructions for overlying a window over the displayable form of the document even if other windows or frames already overly the displayable form of the document;
a specific act of detecting that a pointer has moved to a certain region of the displayable form of the document; and
a specific act of executing the computer executable instructions to thereby implement the following:
a specific act of retrieving contextual help in response to the movement of the pointer to the certain region; and
a specific act of overlaying the contextual help over the displayable form of the document after retrieving the content.

16. In a network system that includes a server computer system network connectable to a client computer system, the server computer system hosting a document, the client computer system capable of interpreting the document for subsequent display of a displayable form of the document, a method of the client computer system overlaying content over the displayable form of the document in response to an event, the method comprising the following:
a specific act of displaying the displayable form of the document;
a specific act of displaying a first window over a portion of the displayable form of the document;
a specific act of receiving a user input designating the movement of a pointer to a certain region of the displayable form of the document;
a specific act of retrieving content associated with the certain region in response to receiving the user input designating the movement of a pointer to the certain region of the displayable form of the document; and
a specific act of displaying the retrieved content in a second window over the displayable form of the document at least partly during the specific act of displaying the first window over the displayable form of the document.

17. A method in accordance with claim 16, wherein the specific act of receiving a user input designating the movement of a point to a certain region of the displayable form of the document comprises the following:
a specific act of detecting a pointing device cursor within the certain region.

18. A method in accordance with claim 16, wherein the specific act of receiving a user input designating the movement of a pointer to a certain region of the displayable form of the document comprises the following:
a specific act of detecting the movement using an OnMouseOver handler.

19. A method in accordance with claim 16, wherein the specific act of retrieving content associated with the certain region in response to receiving the user input designating the movement is implemented by a scriptlet.

20. A method in accordance with claim 16, wherein the specific act of displaying the retrieved content in a second window over the displayable form of the document is implemented by a scriptlet.

21. In a network system that includes a server computer system network connectable to a client computer system, the server computer system hosting a document, the client computer system capable of interpreting the document for subsequent display of a displayable form of the document, a computer program product for implementing a method of the client computer system overlaying content over the displayable form of the document in response to an event, the computer program produce comprising a computer-readable medium having stored thereon the following:
computer-executable instructions for causing the displayable form of the document to be displayed;
computer-executable instructions for detecting the receipt of a user input designating the movement of a pointer to a certain region of the displayable form of the document;
computer-executable instructions for retrieving content associated with the certain region in response to receiving the user input designating the movement of a pointer to the certain region of the displayable form of the document; and
computer-executable instructions for causing the retrieved content to be displayed in a window over the displayable form of the document while another window is also being displayed over the displayable form of the document.

22. A computer program product in accordance with claim 21, wherein the computer-readable medium is a physical storage media.
